(19) United States
(12) Patent Application Publication
(10) Pub. No.: US 2008/0133293 A1
(43) Pub. Date: Jun. 5, 2008

(54) Method for producing on-time, on-budget, on-spec outcomes for IT software projects

(76) Inventor: K. Scott Gordon, Pennington, NJ (US)

Correspondence Address: Dr. K. Scott Gordon, 8 Linden Lane, Pennington, NJ, 08534, US

(21) Appl. No.: 11/825,380

(22) Filed: Jul. 5, 2007

Related U.S. Application Data
(60) Provisional application No. 60/818,640, filed on Jul. 5, 2006.

(51) Int. Cl. G06Q 10/00; G06F 17/00

(52) U.S. Cl. 705/7

(57) ABSTRACT

Industry statistics show that there is a persistent and high rate of IT Projects that fail to meet their goals in terms of budget, schedule, or user satisfaction. My invention is based on the observation that the software development process produces undesirable outcomes when there are inconsistencies between certain process artifacts. I refer to such inconsistencies as breakpoints (or alternatively as breakage points). Breakpoints cause there to be an undesirable divergence between what was expected as the outcome and what actually transpires as the outcome.

My invention consists of a method for preventing undesirable outcomes in the software development process by: identifying the potential breakpoints within a specific instance of a business process; applying a set of procedures to detect the existence and severity of actual breakpoints; and applying curative measures to remove detected breakpoints and applying proactive measures to prevent the development of breakpoints.

### CROSS-REFERENCE TO RELATED APPLICATIONS

This application claims the benefit of Provisional Patent Application Ser. No. 60/818,640, filed Jul. 5, 2006.

### PROBLEM TO BE SOLVED AND DEFINITION OF A BREAKPOINT

Much of the world depends on software to perform critical operations in business, and typically corporations and organizations execute IT projects to develop for themselves the software that they require to run their businesses. Industry statistics show that there is a persistent and high rate of IT Projects that fail to meet their goals in terms of budget, schedule, or user satisfaction. My invention is based on the observation that the software development process produces undesirable outcomes when there are inconsistencies between certain process artifacts. I refer to such inconsistencies as breakpoints (or alternatively as breakage points). Breakpoints cause there to be an undesirable divergence between what was expected as the outcome and what actually transpires as the outcome. This situation is particularly prevalent in corporations and organizations that are not in the business of developing software to be sold to others but rather are developing it for their own use.

Examples of process artifacts include user requirements documents, test plans, and business cases, but also include organizational artifacts which may not be documented, such as average tenure of senior executives, staff downsizing initiatives, and the nature of any governance forums that might exist.

An example of a breakpoint would be an inconsistency between the information in the user requirements document and the business case—perhaps the business case authorizes spending on an improved customer service system, but the user requirements call for improvements in a financial accounting system or, more typically, are vague and ambiguous as to what they are calling for.

I categorize breakpoints as being one of four types, although this categorization is not meant to limit the generality of the definition of breakpoints as given above:
1. Information breakpoints, for example when the specifications for creating the software are inconsistently described in two or more artifacts;
2. Resource breakpoints, for example when the human resources required to perform task processes are inconsistently described in two or more artifacts;
3. Timing breakpoints, for example when there are inconsistencies between the timing of process related events, as described in two or more artifacts.
4. Enterprise breakpoints, for example when there are inconsistencies as to how the process will be managed when compared to a set of process-management best practices.

It must be noted that the inconsistencies are not always as obvious as ‘night and day’ and can have the nature of an ambiguity (the artifacts could be interpreted differently); a contradiction (the artifacts make irreconcilable statements); a discrepancy (the artifacts have unintentional differences); or a disagreement (the artifacts are explicitly opposed to one another).

It is the inherent interdependence of artifacts in the software development process that causes their divergence to result in undesirable outcomes. Software development relies on multiple teams of human personnel executing highly interdependent tasks which are directly or indirectly subject to, or which create or modify, the process artifacts. Moreover it is typical for the artifacts to have a parent-child relationship (i.e. the content of one is dependent on the content of the other), and so inter-artifact inconsistencies can dangerously propagate to other artifacts, exacerbating divergence.

### MY INVENTION

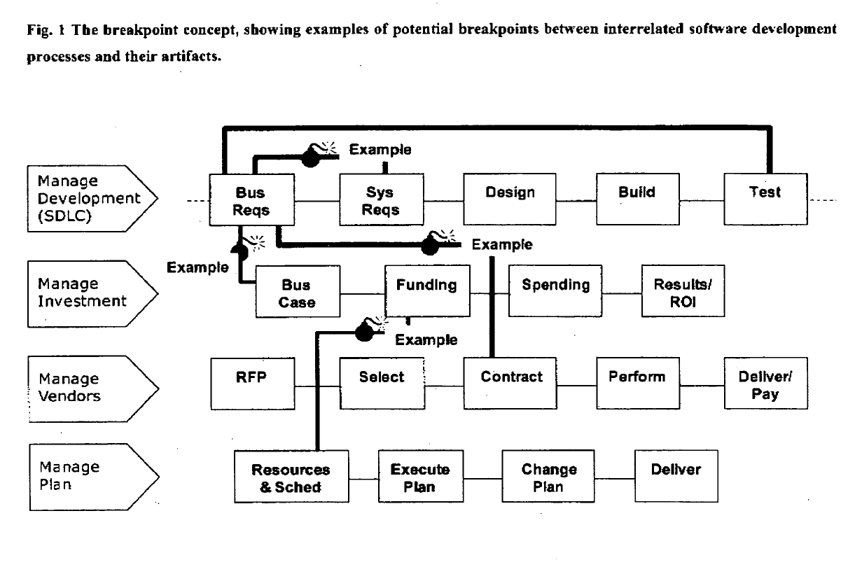

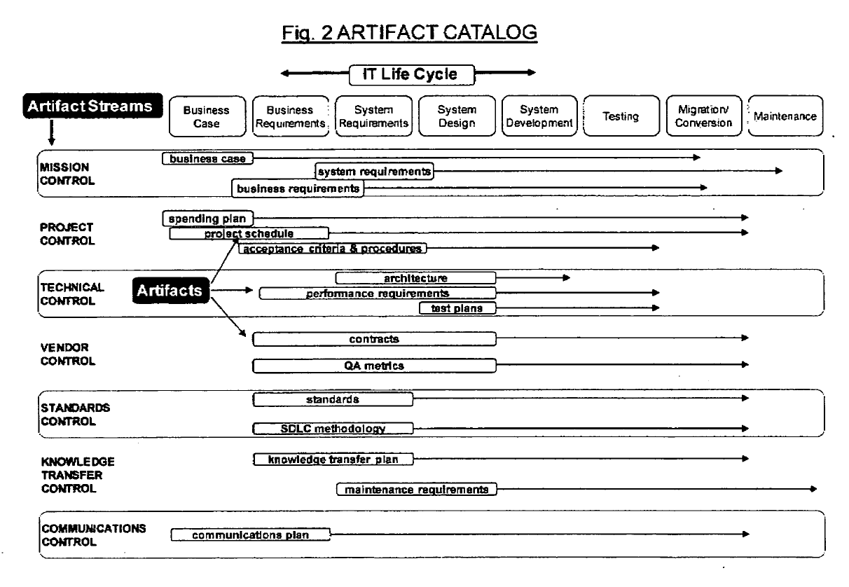

My invention consists of a method for preventing undesirable outcomes in the software development process by:
A. identifying the potential breakpoints (as defined in Section 1 above) within a specific instance of a business process using a catalog of process artifacts augmented by human inspection (see FIGS. 1 and 2 for illustrative examples);
B. applying a set of procedures to detect the existence and severity of actual breakpoints;
C. applying curative measures to remove detected breakpoints and applying proactive measures to prevent the development of breakpoints.

Here is how the three steps of my invention work.

1. The first step consists of an inspection of the process environment, typically by a human inspector skilled in software development project management. The inspector makes reference to a catalog of potential process artifacts that may be found on the project, but may also rely on experience to identify other artifacts. My catalog of artifacts is shown in FIG. 2 by way of example, and is not meant to limit the number or nature of actual breakpoints that might be identified on a project. The inspector then determines which artifacts are actually present, in preparation for the next step. The absence of an artifact docs not necessarily imply that the artifact is not required, and its absence could be the source of a breakpoint. The inspector also makes an estimation of how relevant the particular artifact is to the successful outcome of the project.

2. The second step consists of a procedure for detecting breakpoints and determining their severity.
A. Information Breakpoints. In the ease of Information breakpoints, the procedure is three part:
   1. Completeness. Each artifact is inspected for completeness, wherein the inspector determines whether the artifact has apparent specificity and clarity, such that a skilled computer programmer would be clear on what the software is supposed to do. The question being answered is, “Would a programmer know what to program, and does the potential exist for different programming interpretations of the artifact?” The inspector may use qualitative or quantitative methods to establish severity of any breakpoints detected.
   2. Traceability. Where a parent-child relationship exists between artifacts, or should exist, the inspector identifies in each artifact the elemental specifications, typically individual paragraphs containing a single thematic requirement. The quality of Completeness from Step 1 will influence the effectiveness with which this identification can be done. The inspector then attempts to trace the parent-child relationship between elements in the artifacts. The inspector will typically require the assistance of the artifact authors to perform this task since the logic of the relationships is best known by them. There are commercially available software tools that assist in the traceability task. The inspector may use qualitative or quantitative methods to establish severity of any breakpoints detected.
   3. Accountability. The last step is for the inspector to determine whether there is accountability for each of the artifacts, meaning whether there is physical evidence of approval of the artifacts' contents (i.e. “sign off”) both by the authors themselves and by the senior manager(s) who will be impacted by the software being developed. The inspector may use qualitative or quantitative methods to establish severity of any breakpoints detected.
B. Resource Breakpoints. For the case of Resource Breakpoints, there is a two-step procedure:
   1. Commitment Conflicts. The inspector will determine whether there is physical evidence of resource-owner commitment for both the number and duration of resources required, which numbers and durations will typically be found in project planning artifacts. The inspector may use qualitative or quantitative methods to establish severity of any breakpoints detected.
   2. Incentive Conflicts. The inspector will determine whether the resources are subject to conflicting incentives between serving the project and their resource owner (i.e. it is typical for the temporary project team to borrow resources from various resource-owning organizations). The applicable incentives may not be formally documented artifacts, and may require interviews to establish their nature. The inspector may use qualitative or quantitative methods to establish severity of any breakpoints detected.
C. Timing Breakpoints. For the case of Timing Breakpoints, there is a three-step procedure:
   1. Sponsor-Related Schedule Conflicts. The inspector will determine whether there is risk that the project duration will overrun the sponsor's tenure or commitment. This information is likely to be revealed by interviews. The inspector may use qualitative or quantitative methods to establish severity of any breakpoints detected.
   2. Technology-Related Schedule Conflicts. The inspector will determine whether there is risk that technology obsolescence will occur during the project. This information is likely to be revealed by interviews. The inspector may use qualitative or quantitative methods to establish severity of any breakpoints detected.
   3. Market-Related Schedule Conflicts. The inspector will determine whether there is risk that market/user need will change during the project. This information is likely to be revealed by interviews. The inspector may use qualitative or quantitative methods to establish severity of any breakpoints detected.
D. Enterprise Breakpoints. For the case of Enterprise Breakpoints, the procedure consists of inspecting the management practices within the enterprise executing the process to determine whether they favorably compare to process-management best practices, as judged by a human inspector skilled in software development project management. For example, unclear lines of management, authority for approving required decisions would be considered a breakpoint. The inspector will typically use qualitative methods to establish severity of any breakpoints detected

3. The third step consists of using the results of steps one and two to formulate action plans to prevent or remove breakpoints. The means deployed will depend on the type of breakpoint.
A. Information Breakpoints. If the artifacts are early in their formation, deficiencies in Completeness, Traceability, or Accountability can be avoided by instituting standard practices amongst the authors which are based on the criteria the inspectors use to determine deficiencies (sec step 2 of the invention). If deficiencies are already present, then the breakpoints can be removed by commissioning rework of the artifacts by the authors, using the standards stated above.
B. Resource Breakpoints. If the artifacts are early in their formation, deficiencies in Commitment or Incentive can be avoided by instituting appropriate resource management rules that are based on the criteria that inspectors use to determine deficiencies (see step two of the invention). If deficiencies are already present, then the breakpoints can be removed by obtaining appropriate changes to resource management practices from the resource-owning managers.
C. Timing Breakpoints. If the artifacts are early in their formation, deficiencies in Sponsor, Technology, or Market timing can be avoided by judicious planning, using for a guide the standards that inspectors use to determine deficiencies (see step 2 of the invention). If deficiencies are already present, then the breakpoints can be removed by securing commitments from the project planners to modify their plans accordingly.
D. Enterprise Breakpoints. Typically this type of breakpoint is embedded in the management practices of the enterprise. Removal of the breakpoint is achieved by alerting management to the negative consequences of such management practices. apprising them of the best practices that can remediate the situation, and soliciting their agreement to make the necessary changes to management practices.

### PRIOR ART

Undesirable outcomes for IT software projects are as old as the industry and many measures have been taken to overcome the problem.

Computer programming languages have evolved significantly form the early days of machine language to modern computer languages, such as Java, C⁺⁺, etc. This has reduced the incidence of errors in complex programs by allowing the programmer to construct software from higher level logical concepts, leaving the details to the automated language compiler.

Much standardization has also occurred in what are called Software Development Life Cycle methodologies (SDLC's), which consist of standardized steps to be followed in the construction of software (a simple one is shown at the top of FIG. 2). This has the benefit of organizing all the tasks and resources according to a standardized plan, and of allowing workers from other departments or companies to quickly adapt to new projects.

The software industry has done much to encourage good work practices, the most prominent example of which is a quality rating system called the Capability Maturity Model (CMM) developed by the Software Engineering Institute at Carnegie-Mellon University. There are five CMM levels, each one signifying a higher level of organizational competence in software development. Ratings are awarded by independent examiners.

Lastly, automated software programs (referred to as ‘tools’) are continually evolving to help software development organizations more capably manage the complexity of a project. An example particularly germane to this invention is the existence of so-called traceability tools that facilitate the performance of a traceability inspection by organizing the voluminous textual information associated with the artifacts (an example is Requisite Pro from IBM's Rational Software subsidiary). These tools are text organizers and rely on human inspection to determine the actual tracing of parent-child relationships.

All of this prior art serves the purpose of encouraging or facilitating good practices for software development, but docs not provide a method for preventing or removing errors should good practices not be followed, a problem my invention overcomes.

I claim the following:

1. I claim a method for preventing undesirable outcomes in the software development process by:
A. identifying the potential breakpoints (as defined in Section 1 above) within a specific instance of a business process using a catalog of process artifacts augmented by human inspection (sec FIGS. 1 and 2 for illustrative examples);
B. applying a set of procedures to detect the existence and severity of actual breakpoints;
C. applying curative measures to remove detected breakpoints and applying proactive measures to prevent the development of breakpoints.
I have described my invention and how it can be used to produce improved outcomes in IT Software Projects. There are other ways in which my invention could be used.
For example, my invention could be used on other business processes in which specifications or rules (artifacts of the process) are used to guide the process to produce the desired outcome. Breakpoints associated with these specifications and rules could be detected, prevented, and removed with my invention.
Although my invention describes an environment in which specifications and rules (i.e. artifacts) often have a dynamic nature, being created during the project, often with parent-child relationships, my invention would also apply to situations where the process is subject to relatively static specifications and rules (sometimes referred to as Methods and Procedures, or M&P's).
Although my invention describes a method in which skilled human inspectors perform much of the work, computer programs could also be used to perform such tasks by embedding in them sufficient logic to assist, or even replace, the skilled human inspector.
IT Software Projects sometimes requires coordination with other IT Software Projects to ensure a successful outcome. Although my invention describes a method for detecting and removing break points within a single IT Software Project, the method could also be used to detect and remove breakpoints between one or more IT Software Projects. For example, two projects could be have inconsistencies in the requirements they are placing on the same computer system.

2. I claim a method for inferring whether breakpoints are present in a process environment that does not require the actual measurement of artifacts. This method is not an alternative to the method in claim #1, but rather supports that method by providing, by inference, a preliminary rapid assessment of where breakpoints might exist, and their relative severity. In this method, a human inspection is made of the process environment for the existence and effectiveness of process controls that would prevent breakpoints. If the process controls for preventing breakpoints are deemed weak or insufficient, then one can infer that breakpoints are likely in that process environment. For example, one might determine that there is no procedure for the authors of dependent (i.e. parent-child) documents to verify that the child document faithfully renders the intent of the parent document. In such a case, there is a likelihood that there will be inconsistencies between the two documents, and hence a breakpoint is inferred. One might use inferred breakpoints to prioritize the attention given to potential breakpoints in the method of claim #1.
